(19) United States
(12) Patent Application Publication
(10) Pub. No.: US 2009/0039557 A1
(43) Pub. Date: Feb. 12, 2009

(54) LOW-EMISSION PBT VIA INJECTION MOLDING WITH VENT APPARATUS

(75) Inventors: Rainer Klenz, Hassloch (DE); Norbert Effen, Lambsheim (DE); Mark Volkel, Ladenburg (DE); Andreas Eipper, Ludwigshafen (DE); Jens Assmann, Mannheim (DE); Michael Dahlke, Ludwigshafen (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/278,442

(22) PCT Filed: Feb. 1, 2007
(86) PCT No.: PCT/EP07/50967

§ 371 Date: Aug. 6, 2008

(30) Foreign Application Priority Data
Feb. 6, 2006 (EP) 06101341.3

(51) Int. Cl. B29C 45/00

(52) U.S. Cl. 264/319

(57) ABSTRACT

A process is proposed for production of low-emission moldings for continuous operating temperatures >50° C. composed of a thermoplastic molding composition comprising
A) from 10 to 99.9% by weight of polybutylene terephthalate or a mixture thereof with polyethylene terephthalate and/or polypropylene terephthalate,
B) from 0.1 to 50% by weight of at least one terpolymer obtainable from
   b1) at least one vinylaromatic monomer,
   b2) at least one C₁-C₄-alkyl (meth)acrylate or (meth)acrylonitrile, and
   b3) from 0.1 to 10% by weight, based on the total weight of components b1) to b3), of at least one monomer which comprises an α,β-unsaturated anhydride, and
C) from 0 to 60% by weight of other additives,
   where the total of the percentages by weight of the components (A) to (C) is 100%, via injection molding, which comprises carrying out the injection molding by means of a vented plastifying unit with a cylinder with inlet aperture for the thermoplastic molding composition, with a screw which conveys and plastifies the thermoplastic molding composition within a screw channel, and with one or more vents for discharge of volatile content from the plastified thermoplastic molding composition from the screw channel outward from the vented plastifying unit.

The invention relates to a process for production of low-emission moldings from thermoplastic molding compositions comprising polybutylene terephthalate.

It is known that when polyesters are processed they are subject to impairment via thermal degradation through cleavage of the ester bond. In particular, polybutylene terephthalate has marked susceptibility to temperature- and residence-time-dependent thermal degradation of the polymer (cf. Kunststoff-Handbuch [Plastics Handbook], W. Becker and D. Braun, Carl Hanser Verlag, Munich, 1992, pages 24 and 46). The heat-aging process here is known to comprise not only thermal stress but also the simultaneous effect of atmospheric oxygen (cf. Kunststoff-Handbuch cited above, page 69).

It is therefore advisable, when processing polybutylene terephthalate on commonly available screw injection molding machines, to select the machine performance and, respectively, the cylinder diameter of the screw injection molding machine in such a way as to minimize the residence time of the polybutylene terephthalate in the screw injection molding machine, in order to minimize thermal degradation (cf. Kunststoff-Handbuch cited above, page 86).

Various applications require availability of polybutylene terephthalate moldings which have a low emissions level in particular at elevated continuous operating temperatures.

A general property of plastics moldings is emission of volatile constituents which are present in the polymer after the manufacturing process or which, for example, are produced via the degradation mentioned above, in particular at elevated temperatures. However, increased emission of volatile constituents is undesirable in many application sectors, for example when the polymer is used for production of moldings for interior trim of motor vehicles, where condensation of vaporized volatile content on the glass panes, in particular on the windshield, forms what is known as fogging deposit, which can impair visibility through the windshield. Another specific application sector is production of headlamp covers, the service properties of which are likewise impaired via fogging through emission of volatile constituents from the plastic.

It was therefore an object of the invention to provide a process which can produce low-emission moldings from polybutylene terephthalate for elevated service temperatures.

The invention consists in a process for production of low-emission moldings for continuous operating temperatures >50° C. composed of a thermoplastic molding composition comprising
A) from 10 to 99.9% by weight of polybutylene terephthalate or a mixture thereof with polyethylene terephthalate and/or polypropylene terephthalate,
B) from 0.1 to 50% by weight of at least one terpolymer obtainable from
   b1) at least one vinylaromatic monomer,
   b2) at least one C₁-C₄-alkyl (meth)acrylate or (meth)acrylonitrile, and
   b3) from 0.1 to 10% by weight, based on the total weight of components b1) to b3), of at least one monomer which comprises an α,β-unsaturated anhydride, and
C) from 0 to 60% by weight of other additives,
   where the total of the percentages by weight of the components (A) to (C) is 100%, via injection molding, which comprises carrying out the injection molding by means of a vented plastifying unit with a cylinder with inlet aperture for the thermoplastic molding composition, with a screw which conveys and plastifies the thermoplastic molding composition within a screw channel, and with one or more vents for discharge of volatile content from the plastified thermoplastic molding composition from the screw channel outward from the vented plastifying unit.

Moldings are termed low-emission here when their fogging performance determined to DIN 75201, but under test conditions more stringent than those of that DIN standard, specifically placing of the test specimen in a beaker covered by a glass plate and the temperature of the beaker is controlled to 160° C. for a period of 24 h, and a glass plate is then tested for haze (wide-angle scattering) using a Haze-Garde plus instrument from Byk Gardner, provides haze values of <20% or else <15% or <10%, determined by the test method stated above.

Surprisingly, it has been found that low-emission moldings for elevated continuous operating temperatures of >50° C. or >80° C., or else >90° C. can be provided in a simple manner, without addition of stabilizers.

Although in principle it was known that thermoplastic molding compositions comprising polybutylene terephthalate can be processed on injection molding machines with vent unit, it was also known, however, that the screw geometries and, respectively, screw lengths needed for this purpose demand a relatively long residence time of the polymer melt in the screw cylinder and therefore that the shot volume and molding weight relationship has to be optimized in order to avoid excessive thermal degradation (cf. Kunststoff-Handbuch cited above, page 88).

Nevertheless, it has surprisingly been found to be possible, despite the known disadvantages stated above in the processing of thermoplastic molding compositions comprising polybutylene terephthalate in injection molding machines with vent unit, to start from specific thermoplastic molding compositions comprising
A) from 10 to 99.9% by weight of polybutylene terephthalate or a mixture thereof with polyethylene terephthalate and/or polypropylene terephthalate,
B) from 0.1 to 50% by weight of at least one terpolymer obtainable from
   b1) at least one vinylaromatic monomer,
   b2) at least one C₁-C₄-alkyl (meth)acrylate or (meth)acrylonitrile, and
   b3) from 0.1 to 10% by weight, based on the total weight of components b1) to b3), of at least one monomer which comprises an α,β-unsaturated anhydride, and
C) from 0 to 60% by weight of other additives,
   and to obtain, via injection molding by means of a vented plastifying unit, polybutylene terephthalate moldings which at continuous operating temperatures >50° C. or >80° C., or else >90° C. are low-emission compared with, although residence time in the injection molding machine with vent unit is increased compared with that in an injection molding machine without vent unit.

### Component A

The thermoplastic molding compositions to be processed according to the invention comprise, as component (A), from 10 to 99.9% by weight, preferably from 30 to 99% by weight, and in particular from 30 to 90% by weight, of polybutylene terephthalate or a mixture thereof with polyethylene terephthalate and/or polypropylene terephthalate. The polybutylene terephthalate or the mixture thereof can preferably comprise up to 1% by weight, with preference up to 0.75% by weight, of 1,6-hexanediol and/or 2-methyl-1,5-pentanediol as other monomer units.

The viscosity number of component (A) is generally in the range from 50 to 220, preferably from 80 to 160, measured in 0.5% by weight solution in a phenol/o-dichlorobenzene mixture (ratio by weight 1:1) at 25° C., according to ISO 1628.

Particular preference is given to polybutylene terephthalates whose carboxy end group content is up to 100 meq/kg, preferably up to 50 meq/kg and in particular up to 40 meq/kg of polybutylene terephthalate. By way of example, the process of DE-A 44 01 055 can be used to prepare these polybutylene terephthalates. Titration methods (e.g. potentiometry) are usually used to determine carboxy end group content.

### Component B

At least one terpolymer, or a mixture composed of two or more, for example from three to five, terpolymers of different structure, for example branched or linear, or of different monomeric structure, e.g. random or block, is used as component (B). Among these, it is preferable to use a terpolymer of one type as component B. Among the preferred terpolymers are those whose structure is substantially linear and substantially random.

A vinylaromatic monomer or a mixture of two or more, e.g. from three to five, different vinylaromatic monomers is used as monomeric unit b1). Examples of vinylaromatic monomers that can be used are styrene and substituted styrenes, such as C₁-C₈-alkyl-ring-alkylated styrenes, e.g. p-methylstyrene or tert-butylstyrene. Among these, particular preference is given to use of styrene and α-methylstyrene or of a mixture of these. Styrene alone is in particular used as b1).

The monomeric unit b2) from which the terpolymer B is obtainable can be a C₁-C₄-alkyl (meth)acrylate or a mixture composed of two or more, e.g. from three to five, different C₁-C₄-alkyl (meth)acrylates, and among these it is preferable to use methyl methacrylate. However, methacrylonitrile or acrylonitrile can also be used as b2). Furthermore, a mixture composed of one or more C₁-C₄-alkyl (meth)acrylates and methacrylonitrile and/or acrylonitrile can be used as b2). Acrylonitrile alone is particularly preferably used as b2).

According to the invention, at least one monomer which comprises an α,β-unsaturated anhydride, or, by way of example, a mixture composed of two or more, e.g. from three to five, such monomers is used as monomeric unit b3) for preparation of the terpolymers B. Aromatic or else aliphatic compounds having at least one anhydride group can be used here. Preference is given to monomers having not more than one anhydride group. Maleic anhydride is particularly preferably used as b3).

According to the invention, the proportion of component b3) in the terpolymer is from 0.1 to 10% by weight, particularly preferably from 0.2 to 6% by weight, in particular from 0.2 to 4% by weight, based on the total weight of components b1) to b3), which give a total of 100% by weight. The proportion of the two other components, b1) and b2), can vary widely and depends primarily on the required miscibility of component A. The proportion of component b1) is generally from 60 to 94.9% by weight, preferably from 61.5 to 89.9% by weight, in particular from 68 to 84.9% by weight, based on the total weight of components b1) to b3), which give a total of 100% by weight. Correspondingly, the amount present in the terpolymers of component b2) is from 5 to 36% by weight, preferably from 10 to 35% by weight, in particular from 15 to 29% by weight.

The molecular weight of the terpolymer can vary widely. Average molar masses in the range from 60 000 to 350 000 g/mol have proven suitable. Molar masses in the range from 80 000 to 300 000 g/mol are often advantageous. Particularly preferred terpolymers have molar masses in the range from 90 000 to 210 000 g/mol. The molar masses stated above are weight averages, determined by means of GPC, as described above.

Various processes can be used for preparation of the terpolymers B, as a function of desired structure. The terpolymers are preferably prepared via free-radical polymerization, particularly preferably via continuous solution polymerization. For this, the monomers can, by way of example, be dissolved in methyl ethyl ketone, and the polymerization can be initiated thermally, or, if desired or if required, an initiator, such as a peroxide, can be added to this solution. The reaction mixture is generally polymerized for some hours at an elevated temperature and then worked up.

The proportion of component (B) in the thermoplastic molding compositions is generally matched to the requirements placed upon the product. The inventive molding compositions preferably comprise from 0.1 to 50% by weight, particularly preferably from 0.5 to 20% by weight, in particular from 1 to 15% by weight, of the terpolymer B, based on the total weight of components A to C.

### Component C

The thermoplastic molding compositions may comprise, as component (C), from 0 to 60% by weight, in particular up to 50% by weight, of other additives and processing aids.

The thermoplastic molding compositions may comprise, as component C), from 0 to 5% by weight, preferably from 0.05 to 3% by weight, and in particular from 0.1 to 2% by weight, of at least one ester or amide of saturated or unsaturated aliphatic carboxylic acids having from 10 to 40 carbon atoms, preferably from 16 to 22 carbon atoms, with aliphatic saturated alcohols or amines having from 2 to 40 carbon atoms, preferably from 2 to 6 carbon atoms.

The carboxylic acids may be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols may be mono- to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines may be mono-, di- or triamines. Examples of these are stearylamine, ethylenediamine, propylenediamine, hexamethylenediamine, di(6-aminohexyl)amine, particular preference being given to ethylenediamine and hexamethylenediamine. Correspondingly, preferred esters or amides are glyceryl distearate, glyceryl tristearate, ethylenediamine distearate, glyceryl monopalmitate, glyceryl trilaurate, glyceryl monobehenate, and pentaerythrityl tetrastearate.

It is also possible to use mixtures of various esters or amides, or esters with amides combined, the mixing ratio here being as desired.

Examples of amounts of other usual additives C) are up to 40% by weight, preferably up to 30% by weight, of elastomeric polymers (also often termed impact modifiers, elastomers, or rubbers).

These are very generally copolymers which have preferably been built up from at least two of the following monomers: ethylene, propylene, butadiene, isobutene, isoprene, chloroprene, vinyl acetate, styrene, acrylonitrile and acrylates and/or methacrylates having from 1 to 18 carbon atoms in the alcohol component.

Polymers of this type are described, for example, in Houben-Weyl, Methoden der organischen Chemie, Vol.14/1 (Georg-Thieme-Verlag, Stuttgart, Germany, 1961), pages 392-406, and in the monograph by C. B. Bucknall, “Toughened Plastics” (Applied Science Publishers, London, UK, 1977).

Some preferred types of such elastomers are described below.

Preferred types of such elastomers are those known as ethylene-propylene (EPM) and ethylene-propylene-diene (EPDM) rubbers.

EPM rubbers generally have practically no double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo[5.2.1.0.2.6]-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM and EPDM rubbers may preferably also have been grafted with reactive carboxylic acids or with derivatives of these. Examples of these which may be mentioned are acrylic acid, methacrylic acid and derivatives thereof, e.g. glycidyl (meth)acrylate, and also maleic anhydride.

Copolymers of ethylene with acrylic acid and/or methacrylic acid and/or with the esters of these acids are another group of preferred rubbers. The rubbers may also comprise dicarboxylic acids, such as maleic acid and fumaric acid, or derivatives of these acids, e.g. esters and anhydrides, and/or monomers comprising epoxy groups. These monomers comprising dicarboxylic acid derivatives or comprising epoxy groups are preferably incorporated into the rubber by adding to the monomer mixture monomers comprising dicarboxylic acid groups and/or epoxy groups and having the general formulae I or II or III or IV

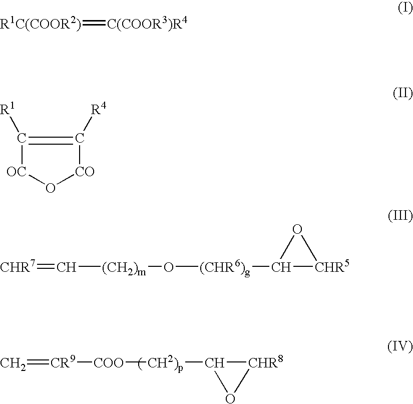

where R¹ to R⁹ are hydrogen or alkyl having from 1 to 6 carbon atoms, and m is a whole number from 0 to 20, g is a whole number from 0 to 10 and p is a whole number from 0 to 5.

R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates comprising epoxy groups, such as glycidyl acrylate and glycidyl methacrylate, and the esters with tertiary alcohols, such as tert-butyl acrylate. Although the latter have no free carboxy groups, their behavior approximates to that of the free acids and they are therefore termed monomers with latent carboxy groups.

The copolymers are advantageously composed of from 50 to 98% by weight of ethylene, from 0.1 to 20% by weight of monomers comprising epoxy groups and/or methacrylic acid and/or monomers comprising anhydride groups, the remaining amount being (meth)acrylates.

Particular preference is given to copolymers composed of
from 50 to 98% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid and/or maleic anhydride, and
from 1 to 45% by weight, in particular from 10 to 40% by weight, of n-butyl acrylate and/or 2-ethylhexyl acrylate.

Other preferred (meth)acrylates are the methyl, ethyl, propyl, isobutyl and tert-butyl esters.

Besides these, comonomers which may be used are vinyl esters and vinyl ethers.

The ethylene copolymers described above may be prepared by processes known per se, preferably by random copolymerization at high pressure and elevated temperature. Appropriate processes are well known.

Other preferred elastomers are emulsion polymers whose preparation is described, for example, by Blackley in the monograph “Emulsion polymerization”. The emulsifiers and catalysts which can be used are known per se.

In principle it is possible to use homogeneously structured elastomers or else those with a shell structure. The shell-type structure is determined by the sequence of addition of the individual monomers; the morphology of the polymers is also affected by this sequence of addition.

Monomers which may be mentioned here, merely in a representative capacity, for the preparation of the rubber fraction of the elastomers are acrylates, such as n-butyl acrylate and 2-ethylhexyl acrylate, corresponding methacrylates, butadiene and isoprene, and also mixtures of these. These monomers may be copolymerized with other monomers, such as styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have two or more shells composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, acrylates or methacrylates, such as methyl acrylate, ethyl acrylate or methyl methacrylate. Besides these, it is also possible to use relatively small proportions of other comonomers.

It has proven advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the general formula

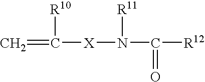

where:
R¹⁰ is hydrogen or C₁-C₄-alkyl,
R¹¹ is hydrogen or C₁-C₈-alkyl or aryl, in particular phenyl,
R¹² is hydrogen, C₁-C₁₀-alkyl, C₆-C₁₂-aryl or —OR¹³
R¹³ is C₁-C₈-alkyl or C₆-C₁₂-aryl, optionally substituted by O- or N-containing groups,
X is a chemical bond or C₁-C₁₀-alkylene or C₆-C₁₂-arylene, or

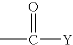

Y is O—Z or NH—Z, and
Z is C₁-C₁₀-alkylene or C₆-C₁₂-arylene.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of this type in which at least one reactive group polymerizes at about the same rate as the other monomers, while the other reactive group (or reactive groups), for example, polymerize(s) significantly more slowly. The different polymerization rates give rise to a certain proportion of double-bond unsaturation in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Some preferred emulsion polymers are listed below. Mention may first be made here of graft polymers with a core and with at least one outer shell, and having the following structure:

| Type | Monomers for the core | Monomers for the envelope |
|---|---|---|
| I | 1,3-butadiene, isoprene, | styrene, acrylonitrile, methyl |
| | n-butyl acrylate, | methacrylate |
| | ethylhexyl acrylate, or | |
| | a mixture of these | |
| II | as I, but with concomitant | as I |
| | use of crosslinking agents | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but with concomitant |
| | | use of monomers having reactive |
| | | groups, as described herein |
| V | styrene, acrylonitrile, | first envelope composed of |
| | methyl methacrylate, or | monomers as described under I |
| | a mixture of these | and II for the core |
| | | second envelope as described |
| | | under I or IV for the envelope |

These graft polymers, in particular ABS polymers and/or ASA polymers, are preferably used in amounts of up to 40% by weight for the impact-modification of PBT, if appropriate in a mixture with up to 40% by weight of polyethylene terephthalate. Blend products of this type are obtainable with the trademark Ultradur®S (previously Ultrablend®S from BASF AG).

Instead of graft polymers whose structure has more than one shell, it is also possible to use homogeneous, i.e. single-shell, elastomers composed of 1,3-butadiene, isoprene and n-butyl acrylate or of copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate-glycidyl acrylate or n-butyl acrylate-glycidyl methacrylate copolymers, graft polymers with an inner core composed of n-butyl acrylate or based on butadiene and with an outer envelope composed of the abovementioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 25 576, EP-A 235 690, DE-A 38 00 603 and EP-A 319 290.

It is, of course, also possible to use mixtures of the types of rubber listed above.

Fibrous or particulate fillers C) which may be mentioned are carbon fibers, glass fibers, glass beads, amorphous silica, asbestos, calcium silicate, calcium metasilicate, magnesium carbonate, kaolin, chalk, powdered quartz, mica, barium sulfate and feldspar, used in amounts of up to 50% by weight, in particular up to 40%.

Preferred fibrous fillers which may be mentioned are carbon fibers, aramid fibers and potassium titanate fibers, and particular preference is given to glass fibers in the form of E glass. These may be used as rovings or in the commercially available forms of chopped glass.

Particular preference is given to mixtures of glass fibers C) with component B) in a ratio of from 1:100 to 1:2, preferably from 1:10 to 1:3.

The fibrous fillers may have been surface-pretreated with a silane compound to improve compatibility with the thermoplastic.

Suitable silane compounds have the general formula:

(X—(CH₂)ₙ)ₖ—Si—(O—CₘH₂ₘ₊₁)₄₋ₖ

where:
X is NH₂—,

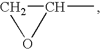

### HO—,

n is a whole number from 2 to 10, preferably 3 to 4,
m is a whole number from 1 to 5, preferably 1 to 2, and
k is a whole number from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which comprise a glycidyl group as substituent X.

The amounts of the silane compounds generally used for surface-coating are from 0.05 to 5% by weight, preferably from 0.5 to 1.5% by weight and in particular from 0.8 to 1% by weight (based on D).

Acicular mineral fillers are also suitable.

For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may, if appropriate, have been pretreated with the abovementioned silane compounds, but the pretreatment is not essential.

Other fillers which may be mentioned are kaolin, calcined kaolin, wollastonite, talc and chalk.

The inventive molding compositions preferably comprise, as component C), talc, which is a hydrated magnesium silicate whose constitution is Mg₃[(OH)₂/Si₄O₁₀] or 3 MgO.4 SiO₂.H₂O. These “three-layer phyllosilicates” have triclinic, monoclinic, or rhombic crystalline form with lamellar habit. Other trace elements that can be present are Mn, Ti, Cr, Ni, Na and K, and the OH group here can have been to some extent replaced by fluoride.

It is preferable to use talc in which the size of 99.5% of the particles is <20 μm. The particle size distribution is usually determined via DIN 6616-1 sedimentation analysis and is preferably:
<20 μm 99.5% by weight
<10 μm 99% by weight
<5 μm 85% by weight
<3 μm 60% by weight
<2 μm 43% by weight

These products are commercially available in the form of Micro-Talc I.T. extra (Omya). Amounts of talc present in the molding compositions are from 0.01 to 20% by weight.

The thermoplastic molding compositions can comprise, as component C), conventional processing aids, such as stabilizers, oxidation retarders, agents to counter thermal decomposition and decomposition due to ultraviolet light, lubricants and mold-release agents, colorants, such as dyes and pigments, nucleating agents, plasticizers, etc.

Examples which may be mentioned of oxidation retarders and heat stabilizers are sterically hindered phenols and/or phosphites, hydroquinones, aromatic secondary amines, such as diphenylamines, various substituted members of these groups, and mixtures of these in concentrations of up to 1% by weight, based on the weight of the thermoplastic molding compositions.

UV stabilizers which may be mentioned, and are generally used in amounts of up to 2% by weight, based on the molding composition, are various substituted resorcinols, salicylates, benzotriazoles, and benzophenones.

Colorants which may be added are inorganic pigments, such as titanium dioxide, ultramarine blue, iron oxide, and carbon black, and also organic pigments, such as phthalocyanines, quinacridones and perylenes, and also dyes, such as nigrosine and anthraquinones.

Nucleating agents which may be used are sodium phenylphosphinate, alumina, silica, and preferably talc.

Other lubricants and mold-release agents are usually used in amounts of up to 1% by weight. Preference is given to long-chain fatty acids (e.g. stearic acid or behenic acid), salts of these (e.g. calcium stearate or zinc stearate) or montan waxes (mixtures of straight-chain saturated carboxylic acids having chain lengths of from 28 to 32 carbon atoms), or calcium montanate or sodium montanate, or low-molecular-weight polyethylene waxes or low-molecular-weight polypropylene waxes.

Examples of plasticizers which may be mentioned are dioctyl phthalates, dibenzyl phthalates, butyl benzyl phthalates, hydrocarbon oils and N-(n-butyl)benzene-sulfonamide.

The thermoplastic molding compositions may also comprise from 0 to 2% by weight of fluorine-containing ethylene polymers. These are polymers of ethylene with a fluorine content of from 55 to 76% by weight, preferably from 70 to 76% by weight.

Examples of these are polytetrafluoroethylene (PTFE), tetrafluoroethylene-hexafluoropropylene copolymers and tetrafluoroethylene copolymers with relatively small proportions (generally up to 50% by weight) of copolymerizable ethylenically unsaturated monomers. These are described, for example, by Schildknecht in “Vinyl and Related Polymers”, Wiley-Verlag, 1952, pages 484-494 and by Wall in “Fluoropolymers” (Wiley Interscience, 1972).

These fluorine-containing ethylene polymers have homogeneous distribution in the molding compositions and preferably have a particle size d₅₀ (numeric average) in the range from 0.05 to 10 μm, in particular from 0.1 to 5 μm. These small particle sizes can particularly preferably be achieved by the use of aqueous dispersions of fluorine-containing ethylene polymers and the incorporation of these into a polyester melt.

The thermoplastic molding compositions may be prepared by methods known per se, by mixing the starting components in conventional mixing apparatus, such as screw extruders, Brabender mixers or Banbury mixers, and then extruding them. The extrudate may be cooled and comminuted. It is also possible to premix individual components and then to add the remaining starting materials individually and/or likewise in a mixture. The mixing temperatures are generally from 230 to 290° C.

In another preferred method of operation, components (B) and, if appropriate, (C) may be mixed with a prepolymer, compounded, and pelletized. The resultant pellets are then solid-phase-condensed, continuously or batchwise, under an inert gas, at a temperature below the melting point of component (A) until the desired viscosity has been reached.

The thermoplastic molding composition is preferably used in pellet form. As is known, vented plastifying units for injection molding have a cylinder with an inlet aperture for the thermoplastic molding composition, and have a screw which conveys and plastifies the pellets within a screw channel, and also have one or more vents for discharge of volatile content from the plastified thermoplastic molding composition from the screw channel outward from the vented plastifying unit. At the end of the vented plastifying unit, the devolatilized and plastified material is injected cyclically into a mold.

There are no restrictions with respect to the vented plastifying units that can be used, and use can be made of commercially available machines.

The selection of the vented plastifying unit is preferably such that the vent or the first of the plurality of vents in the direction of conveying of the screw in the vented plastifying unit has been positioned at a site at which at least 60%, preferably at least 80%, more preferably at least 90%, of the polybutylene terephthalate pellets have been plastified.

The selection of the cross-sectional area of the vent or the total of the cross-sectional areas of the plurality of vents is preferably such that it is in the range from 2 to 70% of the cross-sectional area of the screw, preferably in the range from 10 to 30% of the cross-sectional area of the screw.

The process is particularly suitable for use for production of moldings for use in the motor vehicle sector, in particular for production of headlamp covers.

Inventive examples are used below for further explanation of the invention.

Various polybutylene terephthalates (Ultradur® from BASF AG) listed in the table below were processed to give sheets whose dimensions were 110×110×3 mm, in a Kraus-Maffei KM 250 injection molding machine with a three-zone screw, screw diameter D=50 mm for comparison, and, for the inventive process, in the same injection molding machine which, however, had a plastifying unit with vent. The three-zone screw used for comparative examples CE1 and CE2.1 had, in the direction of conveying, a first zone whose length was 11*D and whose flight depth was 5 mm, a second zone whose length was 6.5*D, in which the flight depth continuously decreased from 5 to 2.5 mm, and a third zone whose length was 4.5*D and whose flight depth was 2.5 mm. A venting screw used in examples IE1 (inventive) and CE2.2 (comparative or non-inventive polybutylene terephthalate pellets, but using an injection molding machine with plastifying unit with vent) had the same diameter (D=50 mm) and total length (22*D) as the comparative three-zone screw, but with the following dimensions, in the direction of conveying:
a 1st zone whose length was 7*D and whose flight depth was 6.5 mm,
a 2nd zone whose length was 2*D and whose flight depth continuously decreased from 6.5 to 2.5 mm,
a 3rd zone whose length was 2*D and whose flight depth was 2.5 mm,
directly downstream of this, a 4th zone whose length was 6*D and whose flight depth was 10.5 mm, an outward vent whose cross-sectional area was 505 mm² having been arranged in this zone,
a 5th zone whose length was 1.5*D and whose flight depth continuously decreased from 10.5 to 3.5 mm, and
a 6th zone whose length was 3*D and whose flight depth was 3.5 mm.

The sheets were produced with the three-zone screw and with the venting screw, in each case with the process parameters listed below:
melt temperature=260° C.
mold temperature=60° C.
screw rotation rate=100 rpm
backpressure (specific)=52 bar
injection pressure=624 bar
hold pressure=507 bar
screw advance rate=50 mm/s
hold pressure time=25 s
cycle time=60 s

The residence time of the Ultradur® material in the injection molding machine with three-zone screw was 80 s, compared with 110 s in the injection molding machine with venting screw.

The comparative examples CE1 and CE2.1 were carried out using a standard injection molding machine, and examples IE1 (inventive) and CE2.2 (comparative or non-inventive polybutylene terephthalate pellets) were carried out using an injection molding machine with plastifying unit with vent.

Examples CE1 and IE1 used inventive polybutylene terephthalate pellets, termed product 1, comprising 62.4% by weight of a component A/1 composed of polybutylene terephthalate whose viscosity number was 130 ml/g, measured in 0.5% strength by weight solution composed of phenol/o-dichlorobenzene, 1:1 mixture at 25° C. and whose carboxy end group content was 34 meq/kg (Ultradur® B4500 from BASF AG), 32.4% by weight of component A/2 of a polybutylene terephthalate whose viscosity number was 105 ml/g, measured under conditions the same as those stated for component A/1 (UI-tradur® B2550 from BASF AG), 5.0% by weight of a component B of a terpolymer based on styrene/acrylonitrile/maleic anhydride in a ratio of 68/29.9/2.1 whose viscosity number was 65 ml/g, measured under conditions the same as those stated for component A/1, and also 0.20% by weight of the additive pentaerythrityl tetrastearate (Loxiol® VPG 1206 from Cognis). The comparative examples CE2.1 and CE2.2 were carried out with a non-inventive polybutylene terephthalate, termed product 2, comprising no terpolymer (component B) and comprising 64.9% by weight of the abovementioned component A/1, 34.9% by weight of A/2, and 0.20% by weight of the additive C.

Each of the sheets was used to produce specimens in the form of disks of diameter 80 mm and thickness 3 mm.

The specimens were tested via characterization of emission properties to DIN 75201, but under test conditions more stringent than those of the stated DIN standard, specifically by placing a specimen in a beaker covered with a glass plate and controlling its temperature to 160° C. for 24 h. The glass plates were tested for haze and clarity using Haze-Gard® test equipment from Byk Gardner.

The table below lists the test results:

| Example | | Haze | Clarity |
|---|---|---|---|
| No. | Product | [%] | [%] |
| CE1 | Product 1 | 17 | 56 |
| IE1 | Product 1 | 4.13 | 78.3 |
| CE2.1 | Product 2 | 71.4 | 96.8 |
| CE2.2 | Product 2 | 67.5 | 97.8 |

The results in the table show that the specimens produced from inventive polybutylene terephthalate pellets from an injection molding machine with plastifying unit with vent have a markedly reduced level of discernible emissions, expressed in terms of haze, with increased clarity.

1. A process for production of low-emission moldings for continuous operating temperatures >50° C. composed of a thermoplastic molding composition comprising
A) from 10 to 99.9% by weight of polybutylene terephthalate or a mixture thereof with polyethylene terephthalate and/or polypropylene terephthalate,
B) from 0.1 to 50% by weight of at least one terpolymer obtainable from
b1) at least one vinylaromatic monomer,
b2) at least one C₁-C₄-alkyl (meth)acrylate or (meth)acrylonitrile, and
b3) from 0.1 to 10% by weight, based on the total weight of components b1) to b3), of at least one monomer which comprises an α,β-unsaturated anhydride, and
C) from 0 to 60% by weight of other additives,
where the total of the percentages by weight of the components (A) to (C) is 100%, via injection molding, which comprises carrying out the injection molding by means of a vented plastifying unit with a cylinder with inlet aperture for the thermoplastic molding composition, with a screw which conveys and plastifies the thermoplastic molding composition within a screw channel, and with one or a plurality of vents for discharge of volatile content from the plastified thermoplastic molding composition from the screw channel outward from the vented plastifying unit.

2. The process according to claim 1, wherein the thermoplastic molding composition is used in the form of pellets.

3. The process according to claim 1, wherein the low-emission moldings are destined for continuous operating temperatures >80° C.

4. The process according to claim 3, wherein the low-emission moldings are destined for continuous operating temperatures >90° C.

5. The process according to claim 1, wherein the vent or the first of the plurality of vents in the direction of conveying of the screw in the vented plastifying unit has been positioned at a site at which at least 60% of the polybutylene terephthalate pellets have been plastified.

6. The process according to claim 5, wherein the vent or the first of the plurality of vents in the direction of conveying of the screw in the vented plastifying unit has been positioned at a site at which at least 80% of the polybutylene terephthalate pellets have been plastified.

7. The process according to claim 6, wherein the vent or the first of the plurality of vents in the direction of conveying of the screw in the vented plastifying unit has been positioned at a site at which at least 90% of the polybutylene terephthalate pellets have been plastified.

8. The process according to claim 1, wherein the cross-sectional area of the vent or the total of the cross-sectional areas of the plurality of vents is in the range from 2 to 70% of the cross-sectional area of the screw.

9. The process according to claim 8, wherein the cross-sectional area of the vent or the total of the cross-sectional areas of the plurality of vents is in the range from 10 to 30% of the cross-sectional area of the screw.

10. The method of production of head-lamp covers, wherein a low emission molding is produced by the process according to claim 1.

11. The process according to claim 2, wherein the low-emission moldings are destined for continuous operating temperatures >80° C.

12. The process according to claim 2, wherein the vent or the first of the plurality of vents in the direction of conveying of the screw in the vented plastifying unit has been positioned at a site at which at least 60% of the polybutylene terephthalate pellets have been plastified.

13. The process according to claim 3, wherein the vent or the first of the plurality of vents in the direction of conveying of the screw in the vented plastifying unit has been positioned at a site at which at least 60% of the polybutylene terephthalate pellets have been plastified.

14. The process according to claim 4, wherein the vent or the first of the plurality of vents in the direction of conveying of the screw in the vented plastifying unit has been positioned at a site at which at least 60% of the polybutylene terephthalate pellets have been plastified.

15. The process according to claim 2, wherein the cross-sectional area of the vent or the total of the cross-sectional areas of the plurality of vents is in the range from 2 to 70% of the cross-sectional area of the screw.

16. The process according to claim 3, wherein the cross-sectional area of the vent or the total of the cross-sectional areas of the plurality of vents is in the range from 2 to 70% of the cross-sectional area of the screw.

17. The process according to claim 4, wherein the cross-sectional area of the vent or the total of the cross-sectional areas of the plurality of vents is in the range from 2 to 70% of the cross-sectional area of the screw.

18. The process according to claim 5, wherein the cross-sectional area of the vent or the total of the cross-sectional areas of the plurality of vents is in the range from 2 to 70% of the cross-sectional area of the screw.

19. The process according to claim 6, wherein the cross-sectional area of the vent or the total of the cross-sectional areas of the plurality of vents is in the range from 2 to 70% of the cross-sectional area of the screw.

20. The process according to claim 7, wherein the cross-sectional area of the vent or the total of the cross-sectional areas of the plurality of vents is in the range from 2 to 70% of the cross-sectional area of the screw.
